(19) United States
(12) Patent Application Publication
(10) Pub. No.: US 2016/0220964 A1
(43) Pub. Date: Aug. 4, 2016

(54) FRESH WATER GENERATION SYSTEM AND FRESH WATER GENERATION METHOD

(71) Applicant: TORAY INDUSTRIES, INC., Tokyo (JP)

(72) Inventors: Yuichi SUGAWARA, Otsu-shi, Shiga (JP); Hiroo TAKABATAKE, Otsu-shi, Shiga (JP)

(73) Assignee: TORAY INDUSTRIES, INC., TOKYO (JP)

(21) Appl. No.: 15/025,771

(22) PCT Filed: Sep. 30, 2014
(86) PCT No.: PCT/JP2014/076217

§ 371 Date: Mar. 29, 2016

(30) Foreign Application Priority Data
Sep. 30, 2013 (JP) 2013-203123

(51) Int. Cl. B01D 65/08; C02F 1/76; C02F 1/50; C02F 3/12; B01D 61/04; C02F 1/44

(52) U.S. Cl. CPC B01D 65/08; B01D 61/04; C02F 1/441; C02F 1/50; C02F 3/1268; C02F 1/76; B01D 2311/12; B01D 2311/04; C02F 2303/04; C02F 2303/20

(57) ABSTRACT

Provided is, in a fresh water generation system, a bactericide dosing method for suppressing growth of biofouling by mixing waters to be treated having different water qualities from each other in order to reduce the amount of energy required to generate fresh water. The present invention relates to a fresh water generation system and a fresh water generation method for obtaining fresh water from water to be treated A1 and dilution water B1 having different osmotic pressures from each other as raw waters, using desalination technique.

### CROSS-REFERENCE TO RELATED APPLICATIONS

This is the U.S. National Phase application of PCT International Application No. PCT/JP2014/076217, filed Sep. 30, 2014, and claims priority to Japanese Patent Application No. 2013-203123, filed Sep. 30, 2013, the disclosures of each of these applications being incorporated herein by reference in their entireties for all purposes.

### FIELD OF THE INVENTION

The present invention relates to a fresh water generation system and a fresh water generation method for obtaining fresh water from water to be treated A1 and dilution water B1 having different osmotic pressures from each other as raw waters, using desalination technique.

### BACKGROUND OF THE INVENTION

In recent years, fresh water is generated using a reverse osmosis membrane in water-scarce regions when useable fresh water is generated from water having high salt concentration. For example, in a disclosed method (for example, Patent Document 1), a two-stage treatment system with reverse osmosis membranes, which feeds concentrate (water in which salts or impurities are concentrated therein) in a second-stage reverse osmosis membrane module back into feed water at a first stage, includes an adsorbing resin tower on a backfeed path for the concentrate, whereby the water quality of permeate is improved by using reverse osmosis membranes of two stages, and an increase in the solute concentration of feed water to be fed into a first-stage reverse osmosis membrane module is suppressed.

In order to achieve further energy saving in water treatment technique, a method in which fresh water is generated by mixing concentrate which is discharged via semipermeable membrane treatment of wastewater such as sewage and industrial wastewater, with water having high salt concentration, is proposed (for example, Patent Document 2).

### PATENT DOCUMENT

Patent Document 1: JP-A-2008-55317

Patent Document 2: WO 2011/021415

### SUMMARY OF THE INVENTION

In the fresh water generation using the reverse osmosis membranes disclosed in Patent Document 1, a salt concentration is high, and a large amount of energy is required to generate fresh water, which is not economical.

The present inventors have found the new fact that biofouling is likely to occur in a case where water having high salt concentration is mixed with dilution water and the mixed water is subjected to a reverse osmosis membrane treatment, as compared to a case where only water having high salt concentration or only dilution water is treated with a membrane. In order to quantitatively measure a biofilm formation rate, each of water having high salt concentration, dilution water, and mixed water (water having high salt concentration:dilution water=1:1) was exposed to a biofilm formation substrate, and the increase rate of the amount of ATP attaching to the surface of the substrate was measured. As a result, the increase rates for the water having high salt concentration, the dilution water, and the mixed water were 20 pg/cm²/day, 150 pg/cm²/day, and 400 pg/cm²/day, respectively. The increase rate for the mixed water was expected to be 85 pg/cm²/day, which was the average value of the increase rates for the water having high salt concentration and the dilution water; however, the increase rate for the mixed water was much greater than the average value. The assumed reason for this is that in a case where bacteria in the water having high salt concentration are in a starvation state due to the lack of nutrient salts, and the water having low salt concentration contains an excessive amount of nutrient salts, the mixing of the water having high salt concentration with the water having low salt concentration causes multiplication of the starving bacteria in the water having high salt concentration. Particularly, in a case where the water having low salt concentration is biologically treated water, since the water having low salt concentration contains a large amount of nutrient salts, the aforementioned phenomenon tends to be prominent.

Patent Document 2 discloses to inject a bactericide into water to be treated, dilution water, and mixed water. However, Patent Document 2 involves a problem that the treatment system illustrated in FIG. 1 of Patent Document 2 is not capable of sufficiently suppressing biofouling since there is no measure to does a proper amount of a bactericide.

In view of the above-mentioned problem and the like, an object of the present invention is to provide a fresh water generation system and a fresh water generation method which are capable of suppressing biofouling of a semipermeable membrane treatment apparatus using mixed water.

In order to achieve the above-mentioned object, a fresh water generation system and a fresh water generation method of the present invention may have any of the following configurations.

(1) A fresh water generation system including:

a first bactericide dosing unit configured to obtain water to be treated A2 by dosing a bactericide into water to be treated A1;

a second bactericide dosing unit configured to obtain dilution water B2 by dosing a bactericide into dilution water B1 having a salt concentration lower than a salt concentration of the water to be treated A1 and having at least one of an organic concentration higher than an organic concentration of the water to be treated A1 and a nutrient salt concentration higher than a nutrient salt concentration of the water to be treated A1;

a mixing unit configured to obtain mixed water by mixing the water to be treated A2 with the dilution water B2;

a third bactericide dosing unit configured to dose a bactericide in an amount represented by the following Expression (1) or (2) into the mixed water:

(XA+XB)≦XM (1)

in which XA, XB and XM each represents an amount of the bactericide as follows:

XA: an amount of the bactericide dosed into the water to be treated A1;

XB: an amount of the bactericide dosed into the dilution water B1; and

XM: an amount of the bactericide dosed into the mixed water,

(CA×FA+CB×FB)/(FA+FB)<CM (2)

in which CA, CB, CM, FA and FB each represents as follows:

CA: a bactericide concentration in the water to be treated A2;

CB: a bactericide concentration in the dilution water B2;

CM: a bactericide concentration in the mixed water after dosing the bactericide into the mixed water;

FA: a flow rate of the water to be treated A1; and

FB: a flow rate of the dilution water B1; and

a first semipermeable membrane treatment unit configured to separate the mixed water into concentrate and permeate.

(2) The fresh water generation system according to (1), in which the amount of the bactericide dosed by the third bactericide dosing unit is represented by the following Expression (3) or (4):

(XA+XB)≦XM≦10(XA+XB) (3)

(CA×FA+CB×FB)/(FA+FB)<CM<10(CA×FA+CB×FB)/(FA+FB) (4).

(3) The fresh water generation system according to (1) or (2), in which the dilution water B1 contains at least one of wastewater, biologically treated water obtained by biologically treating the wastewater, concentrate obtained by subjecting the wastewater to semipermeable membrane treatment, and concentrate obtained by subjecting the biologically treated water to semipermeable membrane treatment.
(4) The fresh water generation system according to (1), further including:

a second semipermeable membrane treatment unit configured to separate second water to be treated E10 which contains wastewater or biologically treated water obtained by biologically treating the wastewater, into concentrate E12 and permeate F,

in which the dilution water B1 contains the concentrate E12.

(5) The fresh water generation system according to (4), further including:

a fourth bactericide dosing unit configured to dose a bactericide U into the second water to be treated E10,

in which the amount of the bactericide dosed by the third bactericide dosing unit is represented by the following Expression (5) or (6):

(XA+XB+X2)≦XM (5)

in which X2 represents an amount of the bactericide dosed into the second water to be treated E10)

(CA×FA+CB×FB+C2×F2)/(FA+FB+F2)<CM (6)

in which C2 represents a bactericide concentration in the second water to be treated E10 after dosing the bactericide into the second water to be treated E10, and F2 represents a flow rate of the second water to be treated E10).

(6) The fresh water generation system according to (5), in which the amount of the bactericide dosed by the third bactericide dosing unit is represented by the following Expression (7) or (8):

(XA+XB+X2)≦XM≦10(XA+XB+X2) (7)

(CA×FA+CB×FB+C2×F2)/(FA+FB+F2)<CM<10(CA×FA+CB×FB+C2×F2)/(FA+FB+F2) (8).

(7) The fresh water generation system according to any one of (1) to (6), further including:

a bactericide amount adjusting unit configured to adjust the amount of the bactericide dosed by the third bactericide dosing unit so as to be proportional to a temperature of the mixed water.

(8) The fresh water generation system according to any one of (4) to (6), further including:

a bactericide amount adjusting unit configured to adjust the amount of the bactericide dosed by the third bactericide dosing unit so as to be proportional to at least one of a temperature of the mixed water and a recovery ratio of the second semipermeable membrane treatment unit.

(9) The fresh water generation system according to any one of (1) to (8), in which the first to third bactericide dosing units dose at least one bactericide selected from the group consisting of an organobromine compound bactericide, chloramines and chloramine derivatives.
(10) A fresh water generation method including:

a first bactericide dosing step of obtaining water to be treated A2 by dosing a bactericide into water to be treated A1;

a second bactericide dosing step of obtaining dilution water B2 by dosing a bactericide into dilution water B1 having a salt concentration lower than a salt concentration of the water to be treated A1 and having at least one of an organic concentration higher than an organic concentration of the water to be treated A1 and a nutrient salt concentration higher than a nutrient salt concentration of the water to be treated A1;

a mixing step of obtaining mixed water by mixing the water to be treated A2 with the dilution water B2;

a third bactericide dosing step of dosing a bactericide in an amount represented by the following Expression (1) or (2) into the mixed water:

(XA+XB)≦XM (1)

in which XA, XB and XM each represents an amount of the bactericide as follows:

XA: an amount of the bactericide dosed into the water to be treated A1;

XB: an amount of the bactericide dosed into the dilution water B1; and

XM: an amount of the bactericide dosed into the mixed water,

(CA×FA+CB×FB)/(FA+FB)<CM (2)

in which CA, CB, CM, FA and FB each represents as follows:

CA: a bactericide concentration in the water to be treated A2;

CB: a bactericide concentration in the dilution water B2;

CM: a bactericide concentration in the mixed water after dosing the bactericide into the mixed water;

FA: a flow rate of the water to be treated A1; and

FB: a flow rate of the dilution water B1; and

a first semipermeable membrane treating step of separating the mixed water into concentrate and permeate.

(11) A fresh water generation system including:

a second treatment apparatus including a second semipermeable membrane treatment unit configured to generate concentrate E12 and permeate F from water to be treated E10, and a fourth bactericide dosing unit configured to dose a bactericide U into the water to be treated E10; and

a first treatment apparatus including a mixing unit configured to mix the concentrate E12 with water to be treated A1 to obtain mixed water A3, and a first semipermeable membrane treatment unit configured to generate concentrate D and permeate C from the mixed water A3 obtained,

in which the concentrate E12 has a salt concentration lower than a salt concentration of the water to be treated A1, and has at least one of an organic concentration higher than an organic concentration of the water to be treated A1 and a nutrient salt concentration higher than a nutrient salt concentration of the water to be treated A1, and

the bactericides are dosed such that a bactericidal load of the mixed water A3 is higher than a bactericidal load of the water to be treated E10.

(12) The fresh water generation system according to (11), in which the bactericidal load has oxidizing power represented by at least one of a total chlorine and a combined chlorine measured by a DPD method.
(13) The fresh water generation system according to (11), in which the bactericidal load is represented by a D-value (decimal reduction time).
(14) The fresh water generation system according to (11), in which treated water which is treated by each of the first semipermeable membrane treatment unit and the second semipermeable membrane treatment unit has a pH of 4 or less, and the bactericidal load is represented by a hydrogen ion concentration.
(15) The fresh water generation system according to (11), in which treated water which is treated by each of the first semipermeable membrane treatment unit and the second semipermeable membrane treatment unit has a pH of 10 or greater, and the bactericidal load is represented by a hydroxide ion concentration.
(16) The fresh water generation system according to (11), in which the bactericidal load is represented by reducing power which is confirmed by measuring a consumed amount of sodium hypochlorite.
(17) The fresh water generation system according to any one of (11) to (16), in which a bactericide is dosed into one or more of the water to be treated E10, the concentrate E12, the water to be treated A1 and the mixed water A3.

It is possible to suppress biofouling and to efficiently generate fresh water by controlling an amount of a bactericide dosed into semipermeable membrane treatment equipment.

### BRIEF DESCRIPTION OF THE DRAWINGS

FIG. 1 is a flow diagram illustrating a fresh water generation system in a first embodiment of the present invention.

FIG. 2 is a flow diagram illustrating a fresh water generation system in a second embodiment of the present invention.

FIG. 3 is a flow diagram illustrating a fresh water generation system in a third embodiment of the present invention.

FIG. 4 is a flow diagram illustrating a fresh water generation system in a fourth embodiment of the present invention.

FIG. 5 is a flow diagram illustrating a fresh water generation system in a fifth embodiment of the present invention.

FIG. 6 is a flow diagram illustrating a fresh water generation system in a sixth embodiment of the present invention.

FIG. 7 is a flow diagram illustrating a fresh water generation system in a seventh embodiment of the present invention.

FIG. 8 is a flow diagram illustrating a fresh water generation system in an eighth embodiment of the present invention.

### DETAILED DESCRIPTION OF EMBODIMENTS OF THE INVENTION

Hereinafter, preferred embodiments of the present invention will be described with reference to the accompanying drawings. The scope of the present invention is not limited to the embodiments.

### First Embodiment

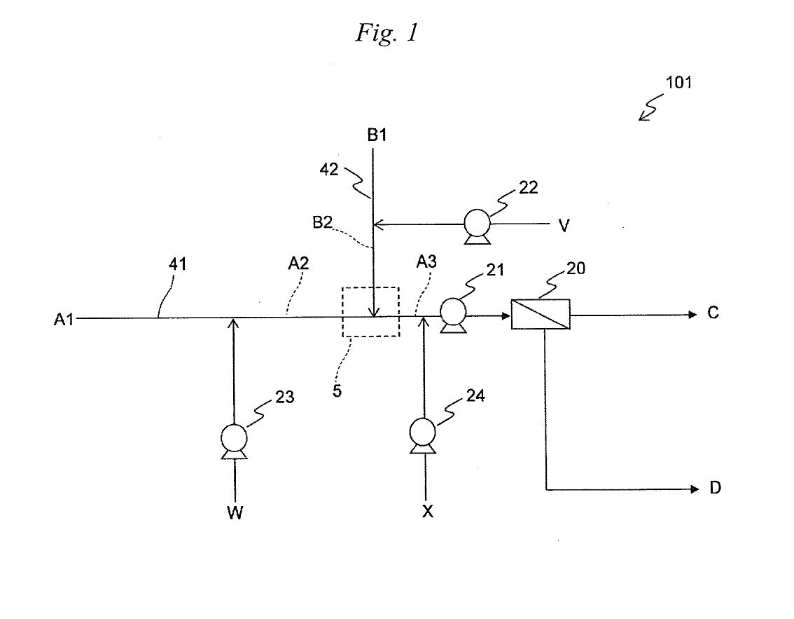

FIG. 1 is a flow diagram illustrating a fresh water generation system in a first embodiment of the present invention. The fresh water generation system in the first embodiment will be described with reference to FIG. 1.

As illustrated in FIG. 1, a fresh water generation system 101 in the first embodiment is a fresh water generation system which separates mixed water obtained by mixing water to be treated A1 and dilution water B1 together, into permeate C and concentrate D via a semipermeable membrane treatment. The fresh water generation system 101 includes a fluid feed pump 21; a first semipermeable membrane treatment unit 20; a first chemical agent feed pump (first bactericide dosing unit) 23; a second chemical agent feed pump (second bactericide dosing unit) 22; a third chemical agent feed pump (third bactericide dosing unit) 24; and a mixing unit 5. The fresh water generation system 101 includes pipes such as flow channels 41 and 42.

The first semipermeable membrane treatment unit 20 includes a semipermeable membrane. The semipermeable membrane is a membrane having semipermeability which permeates a portion of the components in a solution, for example, permeates a solvent, and does not permeate other components. As examples of the semipermeable membrane, a nanofiltration (NF) membrane and a reverse osmosis (RO) membrane are mentioned.

Each of the NF membrane and the RO membrane has properties of being able to reduce the concentration of a solute contained in water (treatment target) to a concentration level in which the water can be used as regenerated water. Specifically, each of the NF membrane and the RO membrane has properties of blocking salts, mineral components, various ions (for example, divalent ions such as calcium ions, magnesium ions and sulfate ions, and monovalent ions such as sodium ions, potassium ions and chlorine ions), and dissolved organic matters such as a humic acid (molecular weight Mw≧100,000), a fulvic acid (molecular weight Mw=100-1,000), alcohol, ether, and saccharides.

The NF membrane is a filtration membrane with an operating pressure of 1.5 MPa or less, a molecular weight cut-off of 200 to 1,000, and a blocking ratio of 90% or less for sodium chloride. A RO membrane has less molecular weight cut-off and a higher blocking performance than the NF membrane. A RO membrane close to the NF membrane is also referred to as a loose RO membrane.

A membrane of any shape, for example, a hollow fiber membrane or a flat sheet membrane can be applied to the first semipermeable membrane treatment unit 20. The first semipermeable membrane treatment unit 20 may include a casing, and a fluid separation element which is accommodated in the casing and includes a hollow fiber membrane or a flat sheet membrane. A plurality of the casing can be operated while being disposed in series and/or in parallel with each other.

Since the semipermeable membrane is assembled to the fluid separation element, the semipermeable membrane can be easily handled. In a case where the fluid separation element includes a semipermeable flat sheet membrane, the fluid separation element preferably includes a cylindrical central pipe having a large number of perforations; a membrane unit wound around the central pipe; and a casing accommodating the central pipe and the membrane unit.

The membrane unit is a laminate including a permeate channel member such as a tricot; a semipermeable membrane; and a feed water channel member such as a plastic net. A plurality of fluid separation elements may be connected in series or in parallel with each other to form a separation membrane module.

Feed water is fed into the membrane unit through one end portion of the fluid separation element. Until the feed water reaches the other end portion of the fluid separation element, the feed water is separated into permeate permeating through the semipermeable membrane, and concentrate which is not allowed to permeate through the semipermeable membrane. The permeate flows through the central pipe, and is taken from the central pipe in the other end portion of the fluid separation element. In contrast, the concentrate is taken from the other end portion of the fluid separation element.

Polymer materials such as cellulose acetate, cellulose-based polymers, polyamides, and vinyl polymers can be used as the material of the semipermeable membrane, particularly, the material of the NF membrane and the RO membrane. Representative examples of the NF membrane and the RO membrane include a cellulose acetate-based or polyamide-based asymmetric membrane, and a composite membrane including a polyamide-based or polyuria-based active layer.

The first chemical agent feed pump 23 is an example of the first bactericide dosing unit which obtains water to be treated A2 by dosing a bactericide W into the water to be treated A1. The first chemical agent feed pump 23 is disposed to dose the bactericide W into the water to be treated A1 flowing through the flow channel 41 on an upstream side of the first semipermeable membrane treatment unit 20 and on an upstream side of the mixing unit 5.

The second chemical agent feed pump 22 is an example of the second bactericide dosing unit which obtains dilution water B2 by dosing a bactericide V into the dilution water B1. The second chemical agent feed pump 22 is disposed to dose the bactericide V into the dilution water B1 flowing through the flow channel 42. The flow channel 42 is connected to the flow channel 41 such that the dilution water B2 merges with the water to be treated A2.

The third chemical agent feed pump 24 is an example of the third bactericide dosing unit which doses a bactericide X into mixed water which is obtained by mixing the water to be treated A2 with the dilution water B2. Specifically, the third chemical agent feed pump 24 is disposed to dose the bactericide X into the fluid flowing through the flow channel 41 on a downstream side of the mixing unit 5.

The amount of the bactericide dosed into the mixed water by the third chemical agent feed pump 24 is set so as to satisfy the following Expression (1) or (2).

(XA+XB)≦XM (1)

In Expression (1),

XA: an amount of the bactericide dosed into the water to be treated A1;

XB: an amount of the bactericide dosed into the dilution water B1; and

XM: an amount of the bactericide dosed into the mixed water.

(CA×FA+CB×FB)/(FA+FB)<CM (2)

In Expression (2), CA, CB, CM, FA and FB each represents as follows:

CA: a bactericide concentration in the water to be treated A2;

CB: a bactericide concentration in the dilution water B2;

CM: a bactericide concentration in the mixed water after dosing the bactericide into the mixed water;

FA: a flow rate of the water to be treated A1; and

FB: a flow rate of the dilution water B1.

More preferably, 1.5×(CA×FA+CB×FB)/(FA+FB)<CM.

In a case where a bactericide is continuously injected, the bactericide concentration is the concentration of the bactericide dosed per unit time and unit volume. In a case where a bactericide is intermittently injected, the bactericide concentration is the concentration of the bactericide dosed per average unit time and unit volume. For example, the concentration of a bactericide dosed per unit time and unit volume is represented in mg/hr/m³. In a case where a 24 mg bactericide is dosed into flowing water with a flow rate of 1 m³/hr for one hour once a day, the concentration of the bactericide dosed per unit time and unit volume is calculated to be 1 mg/hr/m³.

Since excessive dosage of a bactericide is not economical, and the oxidizing power of the bactericide may cause damage to a membrane, more preferably, the amount of the bactericide dosed follows the following Expression (3) or (4).

(XA+XB)≦XM≦10(XA+XB) (3)

(CA×FA+CB×FB)/(FA+FB)<CM<10(CA×FA+CB×FB)/(FA+FB) (4)

The dosed bactericides are not limited to a specific type thereof. Chlorine-based bactericides and bromine-based bactericides are examples of the dosed bactericides. Of these, DBNPA (2, 2-dibromo-3-nitrilopropionamide) which is an organobromine compound bactericide, chloramines, and chloramine derivatives such as chloramine-T (N-chloro-p-toluenesulfonamide, sodium salt) are preferably used.

In a case where the water to be treated A1 or the dilution water B1 is clean, and the dosing of a bactericide thereinto is not required, the bactericide may not be dosed thereinto. For example, in a case where the water to be treated A1 is clean seawater and does not contain nutrient salts or organic matters, even if bacteria present therein, they do not multiply in the flow channel, and thus, the dosing of a bactericide into the water to be treated A1 may not be required. However, since mixed water A3 is likely to cause the occurrence of biofouling as described above, the dosing of a bactericide into the mixed water is required.

The amount of the bactericide dosed into the mixed water A3 is preferably proportional to a bacteria multiplication rate. The dosed amount thereof is desirably increased as the temperature of water which is a bactericide dosing target is increased, and the dosed amount of the bactericide may be determined to be proportional to the water temperature. That is, the fresh water generation system 101 may include thermometers which are respectively disposed on the flow channels 41 and 42 to measure water temperature in each of the flow channels; a dosed amount determination unit which determines the dosed amount of each of the bactericides W, V and X based on measurement results from the thermometers; and a dosed amount control unit which controls the first to third chemical agent feed pumps based on the determination of the dosed amount determination unit. The combination of these configuration elements is referred to as a bactericide amount adjusting unit. Particularly, the amount of the bactericide dosed by the third chemical agent feed pump 24 is preferably determined based on Expressions (1) and (2), and additionally determined to be proportional to the water temperature of the mixed water A3.

The mixing unit 5 is realized by connection between the flow channel 41 and the flow channel 42. The fluid feed pump 21 serves to feed the mixed water A3 into the first semipermeable membrane treatment unit 20 after a bactericide has been dosed into the mixed water A3. Particularly, the fluid feed pump 21 is disposed on the flow channel 41 on a downstream side of the third chemical agent feed pump 24 and on an upstream side of the first semipermeable membrane treatment unit 20.

The dilution water B1 has a salt concentration lower than a salt concentration of the water to be treated A1. That is, the dilution water B1 has an osmotic pressure lower than an osmotic pressure of the water to be treated A1. It is possible to reduce the osmotic pressure of the water to be treated A1, which is to be treated by the first semipermeable membrane treatment unit 20, by mixing the water to be treated A1 with the dilution water B1, thereby being able to reduce power required for filtration by the first semipermeable membrane treatment unit 20. Insofar as the water to be treated A1 and the dilution water B1 have the aforementioned osmotic pressure relationship, any water can be adopted as the water to be treated A1 and the dilution water B1.

Particularly, any of surface water (surface water of a lake, a marsh, a pond, or a river), ground water, wastewater, biologically treated wastewater, and concentrate obtained by treating these waters with a semipermeable membrane, or mixed water thereof is desirably used as the dilution water B1 due to low salt concentration. The dilution water B1 has a salt concentration of 10,000 mg/L or less, preferably 5,000 mg/L or less, and more preferably 3,000 mg/L or less in terms of TDS (Total Dissolved Solids). The salt concentration of the water to be treated A1 is higher than the salt concentration of the dilution water B1, and examples of the water to be treated A1 include seawater, brackish water, and wastewater. The water to be treated A1 has a salt concentration of 25,000 mg/L or greater, and 35,000 mg/L to 50,000 mg/L in the case of seawater, in terms of TDS. The dilution water B1 has at least one of an organic concentration higher than an organic concentration of the water to be treated A1 and a nutrient salt concentration higher than a nutrient salt concentration of the water to be treated A1. The organic concentration is measured by TOC (Total Organic Carbon) or the like. The dilution water B1 has an organic concentration of 6 mg/L or greater, and the water to be treated A1 has an organic concentration of 5 mg/L or less. The nutrient salt concentration is measured by TN (Total Nitrogen), TP (Total Phosphorous), or the like. The dilution water B1 has a TN of 5 mg/L or greater, or a TP of 1 mg/L or greater. The water to be treated A1 has a TN of 2 mg/L or less, or a TP of 0.5 mg/L or less. Particularly, seawater contains a small amount of phosphorous in many cases, and in a case where the TP of the dilution water B1 such as biologically treated water or concentrate obtained by treating the biologically treated water with semipermeable membrane is higher than the TP of the water to be treated A1, the fresh water generation system of the present invention is particularly effective.

The concentration relationship among the salt, the organic matter, and the nutrient salt is maintained after the bactericides are dosed into the water. That is, the concentration relationship between water to be treated and dilution water just before being mixed together (that is, the concentration relationship between the water to be treated A2 and the dilution water B2) satisfies this relationship.

Hereinafter, a fresh water generation method in the aforementioned configuration will be described.

The water to be treated A1 flows to the first semipermeable membrane treatment unit 20 through the flow channel 41. The water to be treated A2 is obtained by dosing the bactericide W into the water to be treated A1 in the flow channel 41 by the first chemical agent feed pump 23. In contrast, the bactericide V is dosed into the dilution water B1 flowing through the flow channel 42 by the second chemical agent feed pump 22. In this manner, the dilution water′ B2 containing the bactericide is obtained. The dilution water B2 flowing through the flow channel 42 merges with the water to be treated A2 flowing through the flow channel 41 at a connection point between the flow channel 41 and the flow channel 42, whereby the water to be treated A2 and the dilution water B2 are mixed together. The mixed water A3, which is obtained via the mixing, flows further to the first semipermeable membrane treatment unit 20 through the flow channel 41. The bactericide X is dosed into the mixed water A3 by the third chemical agent feed pump 24. Thereafter, the mixed water A3, into which the bactericide X is dosed, is separated into the permeate C and the concentrate D by the first semipermeable membrane treatment unit 20.

Since the first chemical agent feed pump 23 and the second chemical agent feed pump 22 respectively dose the bactericides into the water to be treated A1 and the dilution water B1 in the flow channels, the occurrence of biofouling on the wall of the flow channel on a downstream side of each dosing point can be suppressed. Since the bactericide is dosed into the mixed water A3 by the third chemical agent feed pump 24, the occurrence of biofouling on the wall of the flow channel on a downstream side of the dosing point of the bactericide and in the first semipermeable membrane treatment unit 20 can be suppressed.

The present inventors have found the new fact that biofouling is likely to occur in a case where water having high salt concentration is mixed with dilution water and the mixed water is subjected to a reverse osmosis membrane treatment, as compared to a case where only water having high salt concentration or only dilution water is treated with a membrane. In order to quantitatively measure a biofilm formation rate, a biofilm formation substrate was exposed to a flow of water having high salt concentration, a flow of dilution water, and a flow of mixed water, each of which was continuously fed, for a predetermined amount of time, and the increase rates of the amount of ATP attaching to the surface of the substrate were measured. As a result, the increase rates for the water having high salt concentration, the dilution water, and the mixed water were 20 pg/cm²/day, 150 pg/cm²/day, and 400 pg/cm²/day, respectively. The increase rate for the mixed water was expected to be 85 pg/cm²/day, which was the average value of the increase rates for the water having high salt concentration and the dilution water; however, the increase rate for the mixed water was much greater than the average value. The assumed reason for this is that in a case where bacteria in the water having high salt concentration are in a starvation state due to the lack of nutrient salts, and the water having low salt concentration contains an excessive amount of nutrient salts, the mixing of the water having high salt concentration with the water having low salt concentration causes multiplication of the starving bacteria in the water having high salt concentration. The other assumed reason for this is that in a case where foods for bacteria living in the water having high salt concentration and the water having low salt concentration are different from each other, when the water having high salt concentration and the water having low salt concentration are mixed together, the unconsumed remainders of the foods for bacteria complement each other, whereby the bacteria multiply. As such, in a case where different types of water is mixed together and the mixed water is subjected to a semipermeable membrane treatment, since the nutrient salt concentrations or the organic concentrations are different from each other, there is a high risk for multiplication of bacteria. Examples of such a water combination include a combination of seawater and biologically treated wastewater or concentrate obtained by treating the biologically treated wastewater with a semipermeable membrane, a combination of concentrate obtained by treating biologically treated wastewater with a semipermeable membrane and ground water, a combination of seawater and surface water or concentrate obtained by treating the surface water with a semipermeable membrane.

In the first embodiment, it is possible to effectively suppress biofouling by setting the amount of the bactericide dosed by the third chemical agent feed pump 24 as described above.

### Second Embodiment

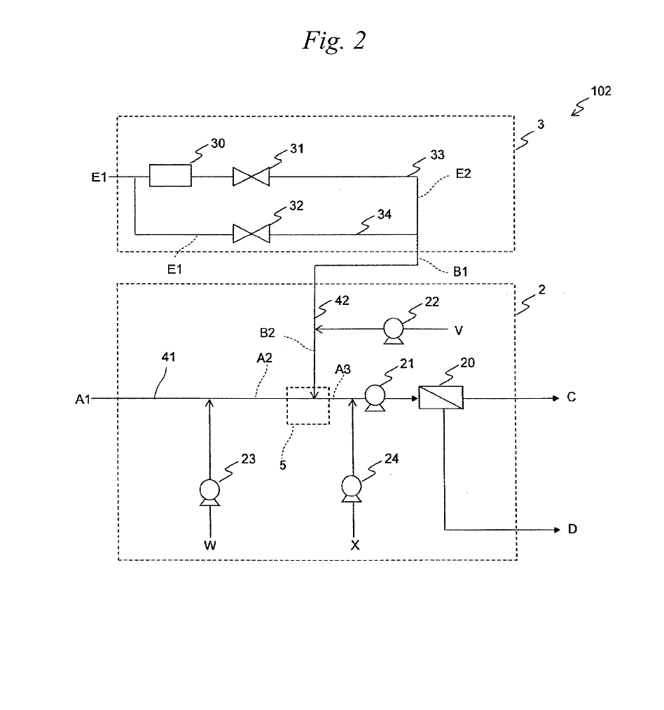

FIG. 2 is a flow diagram illustrating a fresh water generation system in a second embodiment of the present invention. The fresh water generation system in the second embodiment will be described with reference to FIG. 2. In the second embodiment, the same reference signs will be assigned to the same configuration elements as in the first embodiment, and descriptions thereof will be omitted.

A fresh water generation system 102 in the second embodiment includes a salt water treatment apparatus 2 having the same configuration as the fresh water generation system 101 in the first embodiment, and a low salt concentration wastewater treatment apparatus 3.

It is possible to obtain dilution water containing biologically treated water via the low salt concentration wastewater treatment apparatus 3. The biologically treated water is water which is stabilized by biologically oxidizing or reducing pollutants in polluted water with bacteria. Examples of the biologically treated water include water obtained by subjecting sewage to an activated sludge treatment, and water obtained by treating sewage via a membrane bioreactor (MBR).

The low salt concentration wastewater treatment apparatus 3 includes a wastewater treatment unit 30 treating another water to be treated E1 (hereinafter, referred to as “wastewater E1” in order to differentiate from the water to be treated A1); flow rate adjusting units 31 and 32; and flow channels 33 and 34. For example, sewage is used as the wastewater E1. The configuration of the wastewater treatment unit 30 is not limited to a specific configuration. Activated sludge treatment equipment, two-stage treatment equipment using an activated sludge treatment and a microfiltration (MF) membrane or an ultrafiltration (UF) membrane, two-stage treatment equipment using an activated sludge treatment and sand filtration, MBR equipment, or the like can be used as the wastewater treatment unit 30.

A coagulant, a pH adjuster, or an oxidizing agent such as sodium hypochlorite may be dosed into the wastewater E1 on an upstream side of the wastewater treatment unit 30 so as to efficiently operate the wastewater treatment unit 30.

In a case where a membrane or filter is used in the wastewater treatment unit 30, the membrane or filter used is not particularly limited. A flat sheet membrane, a hollow fiber membrane, a tubular membrane, a spool filter, a cloth filter, a metal sintered filter, or other membranes or filters of any shape can be appropriately used in the wastewater treatment unit 30. The material of the membrane or filter is not particularly limited, and preferably contains at least one selected from the group consisting of inorganic materials such as polyacrylonitrile, polyphenylene sulfone, polyphenylene sulfide sulfone, polyvinylidene fluoride, polypropylene, polyethylene, polysulfone, polyvinyl alcohol, cellulose acetate, and ceramic.

In the second embodiment, the wastewater treatment unit 30 removes substances such as suspended substances and impurities, which foul the semipermeable membrane, from the wastewater E1. Accordingly, it is possible to extend the cleaning interval or life of the first semipermeable membrane treatment unit 20. Water obtained in this manner is referred to as biologically treated water E2.

The flow rate adjusting unit 31 is disposed on the flow channel 33 on a downstream side of the wastewater treatment unit 30. The flow rate adjusting unit 31 is capable of adjusting the amount of the biologically treated water E2 flowing to the salt water treatment apparatus 2. The flow rate adjusting unit 32 is disposed on the flow channel 34 which is a bypass line, and adjusts the amount of the wastewater E1 flowing to the salt water treatment apparatus 2 without passing through the wastewater treatment unit 30. Each of the flow rate adjusting units 31 and 32 can be realized by a gate valve, a globe valve, a ball valve, a butterfly valve, or the like as a flow rate adjusting unit. The flow rate can be adjusted by controlling an inverter of a fluid feed pump, which is not illustrated in FIG. 2.

The flow channel 33 delivers the wastewater E1 into the wastewater treatment unit 30 and further extends from the wastewater treatment unit 30 to the salt water treatment apparatus 2. The flow channel 34 branches from the flow channel 33 on an upstream side of the wastewater treatment unit 30, and is connected to the flow channel 33 on a downstream side of the flow rate adjusting unit 31. That is, the flow channel 34 serves as a bypass line through which a portion of the wastewater E1 bypasses the wastewater treatment unit 30 and merges with the biologically treated water E2.

The wastewater E1 and the biologically treated water E2 are mixed together via connection between the flow channel 33 and the flow channel 34. Mixed water obtained in this manner flows into the flow channel 41 through the flow channel 42, as the dilution water B1. As the dilution water B1, only the wastewater E1, only the biologically treated water E2, or mixed water of the wastewater E1 and the biologically treated water E2 may be fed into the salt water treatment apparatus 2 by the flow rate adjusting units 31 and 32.

In the second embodiment, the dilution water B1 is obtained by mixing the wastewater E1 with the biologically treated water E2 treated by the wastewater treatment unit 30. The flow rate adjusting units 31 and 32 are capable of adjusting the mixing ratio of the biologically treated water E2 and the wastewater E1 contained in the dilution water B1, the salt concentration, and the total amount of water obtained via mixing.

The dilution water B1 contains a large amount of nutrient salts in a case where the dilution water B1, that is, water having low salt concentration contains biologically treated water. Therefore, after the water to be treated A1 (the water to be treated A2) and the dilution water B1 (the dilution water B2) are mixed together, as described above, fouling is likely to occur. In contrast, in the second embodiment, it is possible to effectively suppress biofouling by dosing the bactericide by the third chemical agent feed pump 24.

### Third Embodiment

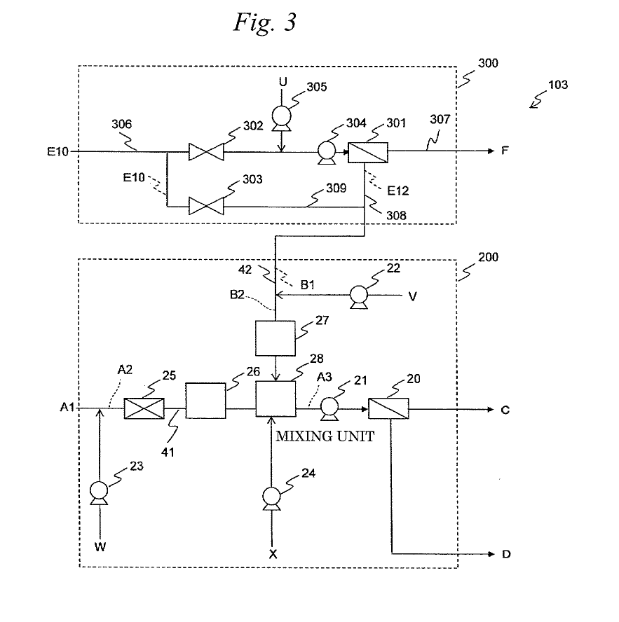

FIG. 3 is a flow diagram illustrating a fresh water generation system in a third embodiment of the present invention. The fresh water generation system in the third embodiment will be described with reference to FIG. 3. In the third embodiment, the same reference signs will be assigned to the same configuration elements as in the first or second embodiment, and descriptions thereof will be omitted.

A fresh water generation system 103 in the third embodiment includes a salt water treatment apparatus 200, and a low salt concentration wastewater treatment apparatus 300 in which second water to be treated E10 is subjected to a semipermeable membrane treatment. The low salt concentration wastewater treatment apparatus 300 is an apparatus to obtain the dilution water B1 from the second water to be treated E10. Specifically, the low salt concentration wastewater treatment apparatus 300 includes a second semipermeable membrane treatment unit 301; flow rate adjusting units 302 and 303; a pump 304; a fourth chemical agent feed pump (fourth bactericide dosing unit) 305; and flow channels 306, 307, 308 and 309.

The wastewater E1, the biologically treated water E2, or mixed water of the wastewater E1 and the biologically treated water E2 is used as the second water to be treated E10. For example, the wastewater treatment unit 30 may be disposed on the flow channel 306 on an upstream side of a branch point at which the flow channel 309 branches from the flow channel 306.

The second semipermeable membrane treatment unit 301 separates the second water to be treated E10, which is fed through the flow channel 306, into concentrate E12 and permeate F. The second semipermeable membrane treatment unit 301 adopts the same configuration as that of the first semipermeable membrane treatment unit 20. The concentrate E12 is fed into the salt water treatment apparatus 200 through the flow channel 308. The permeate F is fed into another process, or to the outside of the system through the flow channel 307.

The flow rate adjusting units 302 and 303 are respectively disposed on the flow channels 306 and 309, and respectively adjust the flow rate of the second water to be treated E10 flowing through the flow channels. The flow rate adjusting units 302 and 303 adjust a mixing ratio of the concentrate E12 and the second water to be treated E10 in the dilution water B1. The flow rate adjusting units 302 and 303 may adopt the same configuration of the flow rate adjusting units 31 and 32.

The pump 304 is disposed on the flow channel 306, and feeds the second water to be treated E10 into the second semipermeable membrane treatment unit 301. Particularly, in the present embodiment, the pump 304 is disposed on a downstream side of the dosing point of the bactericide U, and on an upstream side of the second semipermeable membrane treatment unit 301.

The fourth chemical agent feed pump 305 doses the bactericide U into the second water to be treated E10 in the flow channel 306 on the upstream side of the second semipermeable membrane treatment unit 301. Other bactericides of the same type as those described in the first embodiment are used as the bactericide U.

The second water to be treated E10 is fed into the second semipermeable membrane treatment unit 301 through the flow channel 306. The permeate F and the concentrate E12 obtained by the second semipermeable membrane treatment unit 301 respectively flow through the flow channels 307 and 308. The flow channel 309 which is a bypass line branches from the flow channel 306 on an upstream side of the flow rate adjusting unit 302, and is connected to the flow channel 308.

In this configuration, the bactericide U is dosed into a portion of the second water to be treated E10, and the second water to be treated E10 containing the bactericide U is fed into the second semipermeable membrane treatment unit 301. The concentrate E12 obtained by the second semipermeable membrane treatment unit 301 is fed into the salt water treatment apparatus 200 through the flow channel 308, and is used as the dilution water B1.

As described above, the flow rate adjusting units 302 and 303 are capable of changing a mixing ratio of the concentrate E12 and the second water to be treated E10 in the dilution water B1. For example, in a case where the salt concentration of the concentrate E12 which is obtained by the second semipermeable membrane treatment unit 301 is lower than the salt concentration of the water to be treated A1, only the concentrate E12 may be fed as the dilution water B1 into the salt water treatment apparatus 200. Due to other reasons, for example, in a case where the salt concentration of the concentrate E12 is higher than the salt concentration of the water to be treated A1, or in a case where the amount of the second water to be treated E10 exceeds treatment capacity of the second semipermeable membrane treatment unit 301 and the second water to be treated E10 becomes surplus, mixed water of the concentrate E12 and the second water to be treated E10 may be fed as the dilution water B1 into the salt water treatment apparatus 200. Only the second water to be treated E10 may be fed as the dilution water B1 into the salt water treatment apparatus 200.

In a case where the second water to be treated E10 contains a large amount of suspended substances, an apparatus may be further provided to subject the second water to be treated E10 to UF treatment or sand filtration. The UF treatment apparatus or the sand filter apparatus can be disposed on the flow channel 306 on the upstream side of the branch point of the flow channel 309.

The salt water treatment apparatus 200 includes a pretreatment unit 25; a water to be treated tank 26; a dilution water tank 27; and a mixing tank 28 in addition to the configuration elements of the salt water treatment apparatus 2. The pretreatment unit 25, the water to be treated tank 26, the mixing tank 28, the fluid feed pump 21, and the first semipermeable membrane treatment unit 20 are connected together via the flow channel 41 in the listed sequence. The pretreatment unit 25 is an apparatus in which the water to be treated A1 is subjected to UF treatment or sand filtration. The first chemical agent feed pump 23 doses the bactericide W into the water to be treated A1 on an upstream side of the pretreatment unit 25 on the flow channel 41. The water to be treated tank 26 stores the water to be treated A2.

The flow channels 41 and 42 are connected to the mixing tank 28. The water to be treated A2 and the dilution water B2 are mixed together in the mixing tank 28. In a case where the mixing tank 28 has a small volume, the retention time of the mixed water A3 in the mixing tank 28 is shortened, and thus, multiplication of microorganisms such as bacteria can be suppressed. Insofar as the water to be treated A2 and the dilution water B2 can be sufficiently mixed together, only a pipe may form a mixing unit as in the first and second embodiments. In contrast, the mixing tank 28 is capable of further stabilizing the flow rate.

The dilution water tank 27 is disposed on a downstream side of a dosing point of the bactericide V by the second chemical agent feed pump 22, and on an upstream side of the mixing tank 28 on the flow channel 42. The dilution water tank 27 stores the dilution water B2, that is, the second water to be treated E10 or the concentrate E12 fed by the low salt concentration wastewater treatment apparatus 300, or mixed water of the second water to be treated E10 and the concentrate E12. The water stored in the dilution water tank 27 contains the bactericide dosed by the second chemical agent feed pump 22.

In a case where the dilution water B1 contains the concentrate E12, the bactericide U dosed by the fourth chemical agent feed pump 305 remains in the concentrate E12. However, nutrient salts, bacteria and the like are concentrated in the concentrate E12. Accordingly, a bactericide is preferably further dosed into mixed water of the water to be treated A2 and the dilution water B2.

The amount of the bactericide dosed desirably follows the following expressions.

(XA+XB+X2)≦XM (5)

In Expression (5),

XA: an amount of the bactericide W dosed into the water to be treated A1;

XB: an amount of the bactericide V dosed into the dilution water B1;

X2: am amount of the bactericide U dosed into the water to be treated of the second semipermeable membrane treatment unit; and

XM: an amount of the bactericide X dosed into the mixed water.

(CA×FA+CB×FB+C2×F2)/(FA+FB+F2)<CM (6)

In Expression (6),

CA: a bactericide concentration in the water to be treated A2;

CB: a bactericide concentration in the dilution water B2;

C2: a bactericide concentration in the second water to be treated E10 after dosing the bactericide into the second water to be treated E10;

CM: a bactericide concentration in the mixed water after dosing the bactericide into the mixed water;

FA: a flow rate of the water to be treated A1; and

FB: a flow rate of the dilution water B1; and

F2: a flow rate of the second water to be treated E10.

More preferably, 1.5×(CA×FA+CB×FB+C2×F2)/(FA+FB+F2)<CM.

The amount of the bactericide dosed further desirably follows the following Expression (7) or (8).

(XA+XB+X2)≦XM≦10(XA+XB+X2) (7)

(CA×FA+CB×FB+C2×F2)/(FA+FB+F2)<CM<10(CA×FA+CB×FB+C2×F2)/(FA+FB+F2) (8)

The amount of the bactericide dosed further desirably follows the following Expression (9).

(CA×FA+CB×FB+C2×F2)/(FA+FB+F2)<CM<7(CA×FA+CB×FB+C2×F2)/(FA+FB+F2) (9)

Since the concentration of the nutrient salt or the bacteria which is contained in the concentrate E12 obtained by the second semipermeable membrane treatment unit 301 is increased as the recovery ratio of the semipermeable membrane treatment unit is increased, the amount of the bactericide dosed into the mixed water is desirably increased as the recovery ratio is increased.

In the third embodiment, the fresh water generation system 103 may further include a bactericide amount adjusting unit which adjusts the amount of the bactericide X dosed by the third chemical agent feed pump 24 so as to be proportional to the water temperature of the mixed water A3 and/or the recovery ratio of the second semipermeable membrane treatment unit 301. The recovery ratio of second semipermeable membrane treatment unit 301 is represented by (the volume of the permeate F/the amount of the second water to be treated E10 to be fed into the second semipermeable membrane treatment unit 301). As described above, bacteria are likely to multiply as the temperature of water which is a bactericide dosing target is increased. Since the organic concentration or the nutrient salt concentration is increased as the recovery ratio of the second semipermeable membrane treatment unit 301 is increased, bacteria are likely to multiply.

### Fourth Embodiment

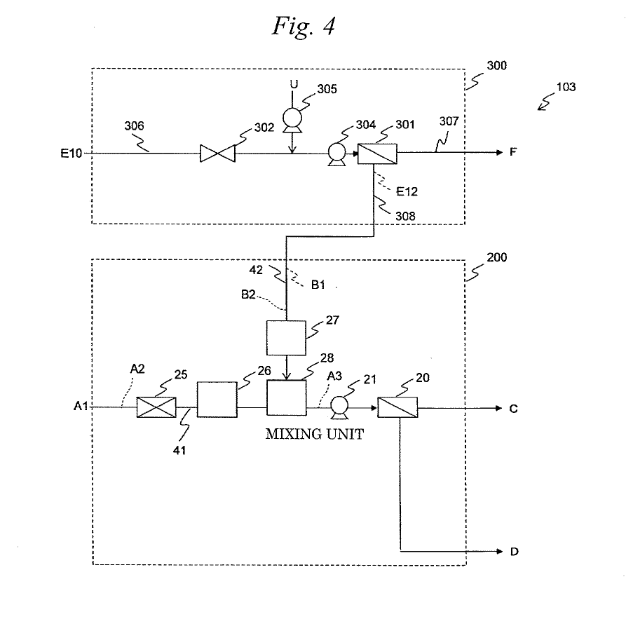

FIG. 4 is a flow diagram illustrating a fresh water generation system in a fourth embodiment of the present invention. The fresh water generation system in the fourth embodiment will be described with reference to FIG. 4. In the fourth embodiment, the same reference signs will be assigned to the same configuration elements as in the first, second, or third embodiment, and descriptions thereof will be omitted.

The bactericide U dosed by the fourth chemical agent feed pump 305 is consumed by the second semipermeable membrane treatment unit 301. However, in a case where the bactericide U does not permeate through the semipermeable membrane, the bactericide U is concentrated according to the recovery ratio of semipermeable membrane treatment.

As described above, since the mixing of water having high salt concentration and dilution water is likely to cause the occurrence of biofouling, in order to prevent the occurrence of biofouling of the first semipermeable membrane treatment unit and the second semipermeable membrane treatment unit, the bactericidal load of the mixed water fed into the first semipermeable membrane treatment unit 20 is desirably set to be higher than the bactericidal load of the second water to be treated E10 fed into the second semipermeable membrane treatment unit 301.

Since a higher concentration bactericide has a higher bactericidal load, it is possible to measure the bactericidal load using a measurement method adapted for a bactericide. For example, in a case where the bactericide is an oxidizing bactericide such as a chlorine-based bactericide or a bromine-based bactericide, it is possible to measure oxidizing power represented as at least one of the converted combined chlorine and the converted total chlorine measured by a DPD method. In a case where the bactericide is an acid or an alkali, it is possible to measure the bactericidal load using a pH meter. In a case where the bactericide is a reducing agent, it is possible to indirectly measure the bactericidal load by simply measuring an ORP. However, since the ORP is dependent on pH, in a case of measuring more accurately, sodium hypochlorite is titrated until being able to detect the oxidizing power using a DPD method, and it is possible to obtain the content of the reducing agent from the titrated amount of the sodium hypochlorite. In a case where the bactericidal load is represented by a hydrogen ion concentration, it is preferable that treated water which is treated by each of the first semipermeable membrane treatment unit and the second semipermeable membrane treatment unit has a pH of 4 or less. In a case where the bactericidal load is represented by a hydroxide ion concentration, it is preferable that treated water which is treated by each of the first semipermeable membrane treatment unit and the second semipermeable membrane treatment unit has a pH of 10 or greater.

In a case where the bactericide is continuously dosed, a measurement value at an arbitrary time can be used. On the other hand, in a case where the bactericide is intermittently dosed, an average value between the start of dosage and the start of subsequent dosage is desirably used. For example, in a case where an oxidizing bactericide is dosed, and 1 ppm combined chlorine is detected for a five-minute interval performed once every 18 hours, the concentration becomes 1×5÷(18×60)=4.6×10⁻³ ppm.

### Fifth Embodiment

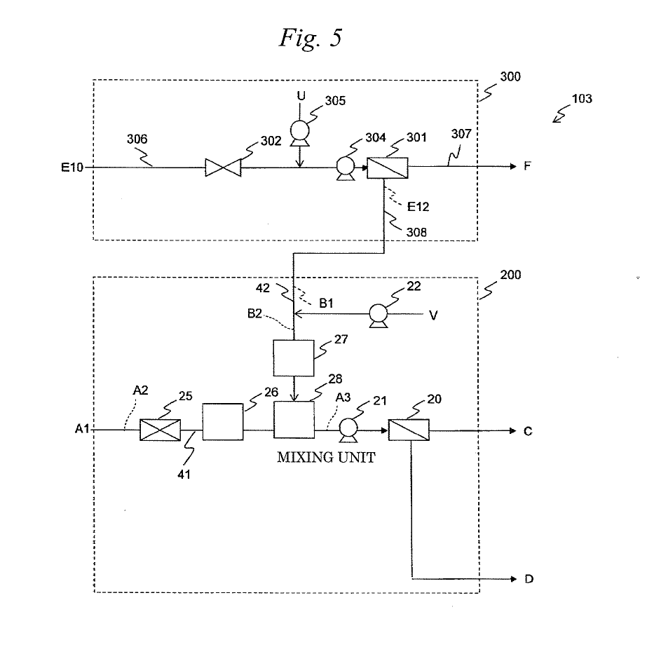

FIG. 5 is a flow diagram illustrating a fresh water generation system in a fifth embodiment of the present invention. The fresh water generation system in the fifth embodiment will be described with reference to FIG. 5. In the fifth embodiment, the same reference signs will be assigned to the same configuration elements as in the first, second, third, or fourth embodiment, and descriptions thereof will be omitted.

In a case where the bactericide U dosed by the fourth chemical agent feed pump 305 is consumed by the second semipermeable membrane treatment unit, or permeates the semipermeable membrane, whereby a sufficient amount of the bactericide does not reach the first semipermeable membrane treatment unit, it is desirable to further dose a bactericide. In the fifth embodiment, the bactericide V is dosed by the pump 22.

In a case where the bactericide U dosed by the fourth chemical agent feed pump 305 and the bactericide V dosed by the pump 22 are oxidizing bactericides of the same type, since a higher concentration bactericide has a higher bactericidal load, it is possible to confirm the bactericidal load using the aforementioned measurement method. On the other hand, in a case where the bactericides are different from each other, for example, in a case where the bactericide U is an oxidizing bactericide, and the bactericide V is an acid bactericide, a D-value (decimal reduction time) is desirably used for comparison between the bactericidal load for the first semipermeable membrane treatment unit and the bactericidal load for the second semipermeable membrane treatment unit. The D-value is the time required to reduce the number of bacteria to one tenth of the initial number of bacteria by sterilization, and the bactericidal load is increased as the time is short.

### Sixth Embodiment

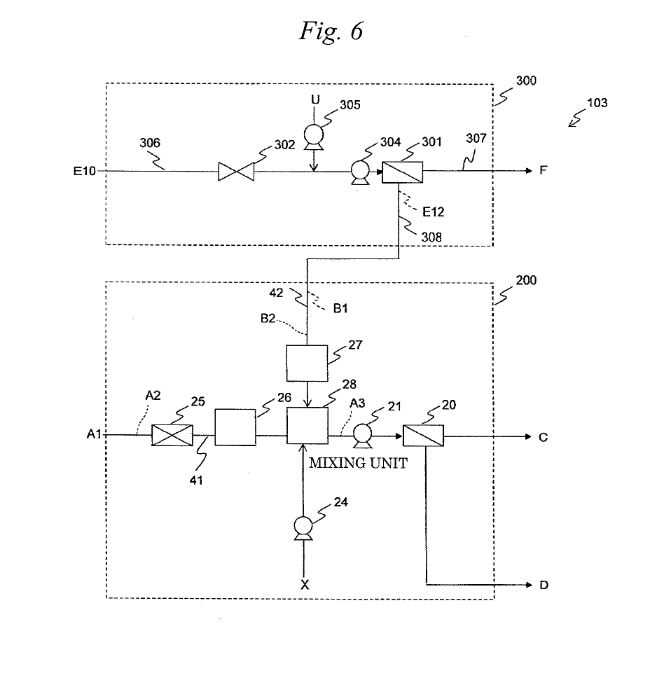

FIG. 6 is a flow diagram illustrating a fresh water generation system in a sixth embodiment of the present invention. The fresh water generation system in the sixth embodiment will be described with reference to FIG. 6. In the sixth embodiment, the same reference signs will be assigned to the same configuration elements as in the first, second, third, fourth, or fifth embodiment, and descriptions thereof will be omitted.

In the sixth embodiment, the third chemical agent feed pump 24 doses the bactericide X into mixed water. Some bactericides such as sodium hypochlorite are consumed by organic matters. Therefore, in a case where the bactericide is desired to be dosed at a position closer to the semipermeable membrane, this embodiment is desirably used.

### Seventh Embodiment

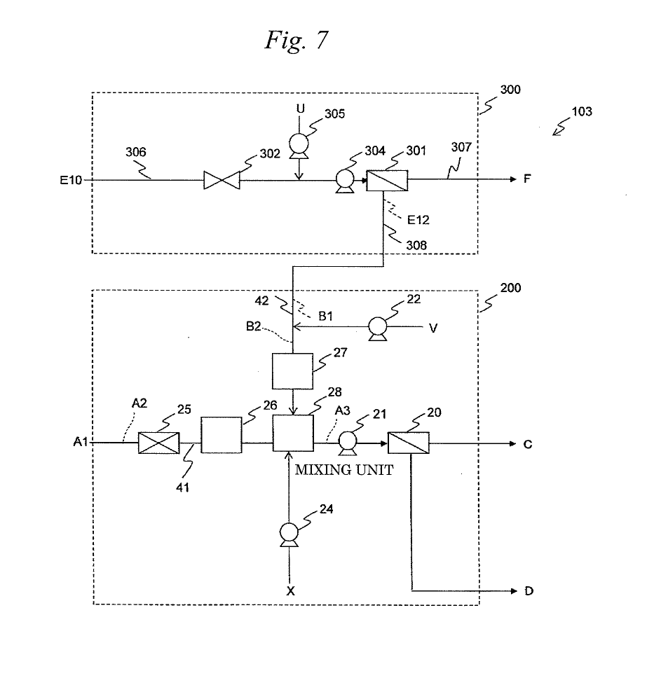

FIG. 7 is a flow diagram illustrating a fresh water generation system in a seventh embodiment of the present invention. The fresh water generation system in the seventh embodiment will be described with reference to FIG. 7. In this embodiment, the same reference signs will be assigned to the same configuration elements as in the first, second, third, fourth, fifth, or sixth embodiment, and descriptions thereof will be omitted.

In the seventh embodiment, the bactericide V is dosed by the pump 22, and the bactericide X is dosed by the third chemical agent feed pump 24. It is possible to change the type or dosage timing of a bactericide by providing multiple dosing points of the bactericide as in the present embodiment. For example, the use of both an acid bactericide and an oxidizing bactericide enables sterilization of both microorganisms weak to acids and microorganisms weak to an oxidizing agent, and is effective in suppressing biofouling. In a case where both an oxidizing bactericide and a reducing bactericide are used, when both are mixed together, both react to each other and cancel effects of each other, and thus, both bactericides are required to be dosed at different timings. The present embodiment is effective in this case.

### Eighth Embodiment

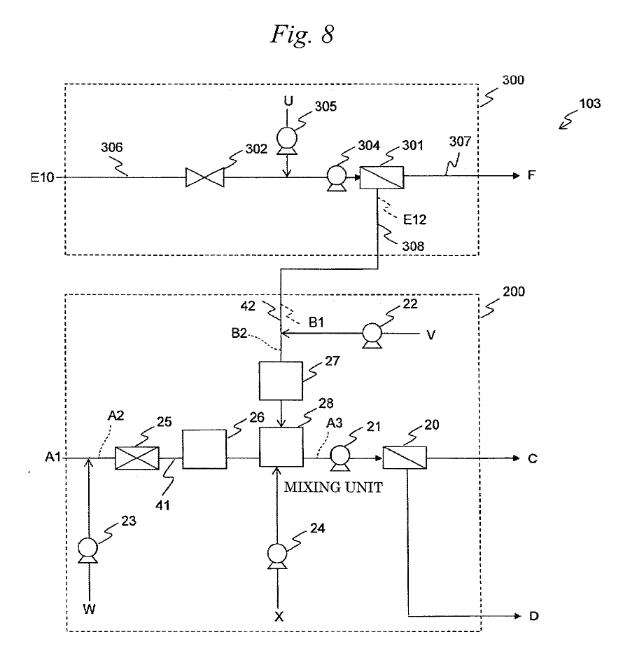

FIG. 8 is a flow diagram illustrating a fresh water generation system in an eighth embodiment of the present invention. The fresh water generation system in the eighth embodiment will be described with reference to FIG. 8. In this embodiment, the same reference signs will be assigned to the same configuration elements as in the first, second, third, fourth, fifth, sixth, or seventh embodiment, and descriptions thereof will be omitted.

In a case where the water to be treated A1 is not clean, and biofouling occurs in the flow channel 41 or the water to be treated tank 26, the dosage of a bactericide thereinto is desirable. The eighth embodiment can be used in this case.

The fresh water generation system of the present invention has been described based on these embodiments; however, the present invention is not limited to these embodiments. The present invention can be realized in various forms insofar as the forms do not depart from the gist of the present invention.

### EXAMPLES

The present invention will be described in more detail based on examples.

### (1) DPD Measurement Method

Specimens were sampled at a position on a downstream side of a bactericide dosing unit and on an upstream side of a pretreatment unit or a membrane module, and from the flow channel 42, and were measured using a Poseidon DPD residual salt checker (CRP-1000) manufactured by Suido Kiko Kaisha, Ltd.

### (2) TOC Measurement Method

The specimens were analyzed using a TNC-6000 (combustion oxidation non-dispersive infrared absorption method) manufactured by Toray Engineering Co., Ltd.

### (3) TN Measurement Method

The specimens were analyzed using a PN-155 (ultraviolet oxidation decomposition method) manufactured by Horiba, Ltd.

### (4) TP Measurement Method

The specimen were analyzed using a PN-155 (ultraviolet oxidation decomposition method) manufactured by Horiba, Ltd.

### (5) TDS Measurement Method

The samples were dried at 105° C. for two hours, and the weights of residue were measured.

### (6) Test Apparatus

Tests were performed using an apparatus having the flow illustrated in FIG. 8. Concentrate was obtained by treating 1400 m³/d of MBR treated water at a recovery ratio of 60% using the second semipermeable membrane treatment unit 301 (TML20-370 manufactured by Toray Industries, Inc.; 7 elements/vessel (1^{st} bank 6 vessels+2^{nd} bank 3 vessels)). Seawater or brackish water (amounting to 550 m³/d) was taken, was treated by the pretreatment unit 25 (HFU-2020 manufactured by Toray Industries, Inc.; 4 modules/train×2 trains), was mixed with the concentrate at a ratio of 1:1, and was treated at a recovery ratio of 50% by the first semipermeable membrane treatment unit 20 (TM840C-160 manufactured by Toray Industries, Inc. for 1^{st} bank: 6 elements/vessel×1 vessel; TM820E-400 for 2^{nd} bank: 6 elements/vessel×3 vessels). DBNPA (Peama Clean PC-11 manufactured by Katayama Nalco Inc.) was dosed as a bactericide immediately prior to the second semipermeable membrane treatment unit 301 and the first semipermeable membrane treatment unit 20. Herein, FA was 550 m³/hr, FB was 560 m³/hr, and F2 was 1400 m³/hr.

The water qualities of the MBR treated water, the concentrate E12, and the seawater A1 are illustrated in the table (mg/L).

TABLE 1

| | TOC | TN | TP | TDS |
|---|---|---|---|---|
| MBR Treated Water E10 | 5.6 | 4.7 | 0.9 | 700 |
| Concentrate E12 | 12.6 | 12 | 2.2 | 1,700 |
| Seawater A1 | 1.5 | 0.3 | 0.04 | 35,000 |
| Brackish water A1 | 1.0 | 0.4 | 0.02 | 25,000 |
| Mixed Water A3 | 6.8 | 6.2 | 1.4 | 18,000 |
| (Seawater) | | | | |
| Mixed Water A3 | 6.7 | 6.0 | 1.2 | 13,000 |
| (Brackish water) | | | | |

### Example 1

### Using Seawater

DBNPA (amounting to 10 mg/L) was dosed into the second semipermeable membrane treatment unit 301 for one hour per day via the fourth chemical agent feed pump 305, and as a result of measurement using a DPD measurement residual salt checker, 10 mg/L (=C2) of combined chlorine was measured. DBNPA (amounting to 1 mg/L) was dosed into the concentrate E12 for one hour per day via the second chemical agent feed pump 22 such that the dosed DBNPA was mixed with the chemical agent dosed by the fourth chemical agent feed pump. As a result of measuring the concentrate E12 using the DPD measurement residual salt checker, 5 mg/L (=CB) of combined chlorine was measured. While the retention time to the first semipermeable membrane treatment unit 20 was taken into consideration, 4 mg/L of DBNPA was dosed into the water to be treated A1 for one hour per day via the first chemical agent feed pump 23 such that the mixing of the dosed DBNPA and the chemical agent dosed by the fourth chemical agent feed pump occurred in the mixed water A3. As a result of measurement using the DPD measurement residual salt checker, 4 mg/L (=CA) of combined chlorine was measured. While the retention time from the second semipermeable membrane treatment unit 301 to the first semipermeable membrane treatment unit 20 was taken into consideration, when the concentrate E12 contained the maximum amount of the DBNPA, 15 mg/L of DBNPA was dosed into the first semipermeable membrane treatment unit 20 for one hour per day via the third chemical agent feed pump. As a result of measurement using the DPD measurement residual salt checker, 18 mg/L (=CM) of combined chlorine was measured. As a result, the second semipermeable membrane treatment unit 301 and the first semipermeable membrane treatment unit 20 could be operated without being cleaned with a chemical agent for five months (DP (differential pressure during passing of the water) of the first semipermeable membrane treatment unit 20 was changed from 150 kPa to 170 kPa). The pretreatment unit 25 could also be operated well.

The above-mentioned Example satisfies Expression (1), that is, (XA (=4 ppm×550 m³/hr)+XB (=1 ppm×560 m³/hr))≦XM (=15 ppm×1110 m³/hr).

The above-mentioned Example satisfies Expression (2), that is, (CA×FA+CB×FB)/(FA+FB)<CM.

The above-mentioned Example satisfies Expression (5), that is, (XA (=4 ppm×550 m³/10+XB (=1 ppm×560 m³/hr)+X2 (=10 ppm×1400 m³/hr))≦XM (=15 ppm×1110 m³/hr).

The above-mentioned Example satisfies Expression (6), that is, (CA×FA+CB×FB+C2×F2)/(FA+FB+F2)<CM.

### Example 2

### Using Seawater

DBNPA (amounting to 10 mg/L) was dosed into the second semipermeable membrane treatment unit 301 for one hour per day via the fourth chemical agent feed pump 305, and as a result of measurement using a DPD measurement residual salt checker, 10 mg/L (=X2) of combined chlorine was measured. DBNPA (amounting to 1 mg/L) was dosed into the concentrate E12 for one hour per day via the second chemical agent feed pump 22 such that the dosed DBNPA was mixed with the chemical agent dosed by the fourth chemical agent feed pump. As a result of measuring the concentrate E12 using the DPD measurement residual salt checker, 5 mg/L (=XB) of combined chlorine was measured.

While the retention time from the second semipermeable membrane treatment unit 301 to the first semipermeable membrane treatment unit 20 was taken into consideration, when the concentrate E12 contained the maximum amount of the DBNPA, 15 mg/L of DBNPA was dosed into the first semipermeable membrane treatment unit 20 for one hour per day via the third chemical agent feed pump. As a result of measurement using the DPD measurement residual salt checker, 17.5 mg/L (=XM) of combined chlorine was measured. As a result, the second semipermeable membrane treatment unit 301 and the first semipermeable membrane treatment unit 20 could be operated without being cleaned with a chemical agent for five months (DP (differential pressure during passing of the water) of the first semipermeable membrane treatment unit 20 was changed from 150 kPa to 180 kPa). However, since a slight amount of biofouling occurred in the pretreatment unit 25, the pretreatment unit 25 was required to be cleaned with a chemical solution.

The above-mentioned Example satisfies Expression (1), that is, (XA (=0 ppm×550 m³/hr)+XB (=1 ppm×560 m³/hr))≦XM 15 ppm×1110 m³/hr).

The above-mentioned Example satisfies Expression (2), that is, (CA×FA+CB×FB)/(FA+FB)<CM.

The above-mentioned Example satisfies Expression (5), that is, (XA (=0 ppm×550 m³/hr)+XB (=1 ppm×560 m³/hr)+X2 (=10 ppm×1400 m³/hr))≦XM (=15 ppm×1110 m³/hr).

The above-mentioned Example satisfies Expression (6), that is, (CA×FA+CB×FB+C2×F2)/(FA+FB+F2)<CM.

### Example 3

### Using Brackish Water

DBNPA (amounting to 10 mg/L) was dosed into the second semipermeable membrane treatment unit 301 for one hour per day via the fourth chemical agent feed pump 305, and as a result of measurement using a DPD measurement residual salt checker, 10 mg/L (=X2) of combined chlorine was measured. DBNPA (amounting to 1 mg/L) was dosed into the concentrate E12 for one hour per day via the second chemical agent feed pump 22 such that the dosed DBNPA was mixed with the chemical agent dosed by the fourth chemical agent feed pump. As a result of measuring the concentrate E12 using the DPD measurement residual salt checker, 5 mg/L (=XB) of combined chlorine was measured. While the retention time to the first semipermeable membrane treatment unit 20 was taken into consideration, 4 mg/L of DBNPA was dosed into the water to be treated A1 for one hour per day via the first chemical agent feed pump 23 such that the mixing of the dosed DBNPA and the chemical agent dosed by the fourth chemical agent feed pump occurred in the mixed water A3. As a result of measurement using the DPD measurement residual salt checker, 4 mg/L (=XA) of combined chlorine was measured. While the retention time from the second semipermeable membrane treatment unit 301 to the first semipermeable membrane treatment unit 20 was taken into consideration, when the concentrate E12 contained the maximum amount of the DBNPA, 15 mg/L of DBNPA was dosed into the first semipermeable membrane treatment unit 20 for one hour per day via the third chemical agent feed pump. As a result of measurement using the DPD measurement residual salt checker, 18 mg/L (=XM) of combined chlorine was measured. As a result, the second semipermeable membrane treatment unit 301 and the first semipermeable membrane treatment unit 20 could be operated without being cleaned with a chemical agent for five months (DP (differential pressure during passing of the water) of the first semipermeable membrane treatment unit 20 was changed from 150 kPa to 170 kPa).

The pretreatment unit 25 could also be operated well.

The above-mentioned Example satisfies Expression (1), that is, (XA (=4 ppm×550 m³/hr)+XB (=1 ppm×560 m³/hr))≦XM 15 ppm×1110 m³/hr).

The above-mentioned Example satisfies Expression (2), that is, (CA×FA+CB×FB)/(FA+FB)<CM.

The above-mentioned Example satisfies Expression (5), that is, (XA (=4 ppm×550 m³/hr)+XB (=1 ppm×560 m³/hr)+X2 (=10 ppm×1400 m³/hr))≦XM (=15 ppm×1110 m³/hr).

The above-mentioned Example satisfies Expression (6), that is, (CA×FA+CB×FB+C2×F2)/(FA+FB+F2)<CM.

### Comparative Example 1

### Using Seawater

DBNPA (amounting to 10 mg/L) was dosed into the second semipermeable membrane treatment unit 301 for one hour per day via the fourth chemical agent feed pump 305, and as a result of measurement using a DPD measurement residual salt checker, 10 mg/L (=X2) of combined chlorine was measured. DBNPA (amounting to 1 mg/L) was dosed into the concentrate E12 for one hour per day via the second chemical agent feed pump 22 such that the dosed DBNPA was mixed with the chemical agent dosed by the fourth chemical agent feed pump. As a result of measuring the concentrate E12 using the DPD measurement residual salt checker, 5 mg/L (=XB) of combined chlorine was measured. While the retention time to the first semipermeable membrane treatment unit 20 was taken into consideration, 4 mg/L of DBNPA was dosed into the water to be treated A1 for one hour per day via the first chemical agent feed pump 23 such that the mixing of the dosed DBNPA and the chemical agent dosed by the fourth chemical agent feed pump occurred in the mixed water A3. As a result of measurement using the DPD measurement residual salt checker, 4 mg/L (=XA) of combined chlorine was measured. While the retention time from the second semipermeable membrane treatment unit 301 to the first semipermeable membrane treatment unit 20 was taken into consideration, when the concentrate E12 contained the maximum amount of the DBNPA, 1 mg/L of DBNPA was dosed into the first semipermeable membrane treatment unit 20 for one hour per day via the third chemical agent feed pump. As a result of measurement using the DPD measurement residual salt checker, 4 mg/L (=XM) of combined chlorine was measured.

As a result, although the second semipermeable membrane treatment unit 301 could be operated without being cleaned with a chemical agent for five months, the DP (differential pressure during passing of the water) of the first semipermeable membrane treatment unit 20 was changed from 150 kPa to 200 kPa within two weeks, and thus, the first semipermeable membrane treatment unit 20 was required to be cleaned with a chemical solution. As a result of disassembling and investigating the membrane of the first semipermeable membrane treatment unit 20, it was determined that biofouling occurred and the cause of the DP (differential pressure during passing of the water) was multiplication of bacteria.

The above-mentioned Comparative Example does not satisfy Expression (1), that is, (XA (=4 ppm×550 m³/hr)+XB (=1 ppm×560 m³/hr))=XM (=1 ppm×1110 m³/hr).

The above-mentioned Comparative Example does not satisfy Expression (2), that is, (CA×FA+CB×FB)/(FA+FB)<CM.

The above-mentioned Comparative Example does not satisfy Expression (5), that is, (XA (=4 ppm×550 m³/hr)+XB (=1 ppm×560 m³/hr)+X2 (=10 ppm×1400 m³/hr))≦XM (=1 ppm×1110 m³/hr).

The above-mentioned Comparative Example does not satisfy Expression (6), that is, (CA×FA+CB×FB+C2×F2)/(FA+FB+F2)<CM.

The present application is based on Japanese Patent Application No. 2013-203123 filed on Sep. 30, 2013, the content of which is incorporated herein by reference.

According to the present invention, it is possible to efficiently produce fresh water with low energy consumption, the fresh water being applicable to the water purification field for waterworks, or the production field for industrial water such as industrial water, food and drug processing water, and semiconductor cleaning water. The present invention can be utilized as an apparatus to obtain fresh water by desalination technique.

### DESCRIPTION OF REFERENCE NUMERALS AND SIGNS

101: FRESH WATER GENERATION SYSTEM
102: FRESH WATER GENERATION SYSTEM
103: FRESH WATER GENERATION SYSTEM
2: SALT WATER TREATMENT APPARATUS
3: LOW SALT CONCENTRATION WASTEWATER TREATMENT APPARATUS
20: FIRST SEMIPERMEABLE MEMBRANE TREATMENT UNIT
21: FLUID FEED PUMP
22: SECOND CHEMICAL AGENT FEED PUMP (SECOND BACTERICIDE DOSING UNIT)
23: FIRST CHEMICAL AGENT FEED PUMP (FIRST BACTERICIDE DOSING UNIT)
24: THIRD CHEMICAL AGENT FEED PUMP (THIRD BACTERICIDE DOSING UNIT)
25: PRETREATMENT UNIT
26: WATER TO BE TREATED TANK
27: DILUTION WATER TANK
28: MIXING TANK
29: PUMP
200: SALT WATER TREATMENT APPARATUS
30: WASTEWATER TREATMENT UNIT
31: FLOW RATE ADJUSTING UNIT
32: FLOW RATE ADJUSTING UNIT
33: FLOW CHANNEL
34: FLOW CHANNEL
300: LOW SALT CONCENTRATION WASTEWATER TREATMENT APPARATUS
301: SECOND SEMIPERMEABLE MEMBRANE TREATMENT UNIT
302: FLOW RATE ADJUSTING UNIT
303: FLOW RATE ADJUSTING UNIT
304: PUMP
305: FOURTH CHEMICAL AGENT FEED PUMP (FOURTH BACTERICIDE DOSING UNIT)
306: FLOW CHANNEL
307: FLOW CHANNEL
308: FLOW CHANNEL
309: FLOW CHANNEL
41: FLOW CHANNEL
42: FLOW CHANNEL
A1: WATER TO BE TREATED (HAVING HIGH SALT CONCENTRATION)
A2: WATER TO BE TREATED (HAVING HIGH SALT CONCENTRATION AND CONTAINING BACTERICIDE)
A3: MIXED WATER
B1: DILUTION WATER
B2: DILUTION WATER (CONTAINING BACTERICIDE)
C: PERMEATE
D: CONCENTRATE
E1: WATER TO BE TREATED (HAVING LOW SALT CONCENTRATION), WASTEWATER
E2: BIOLOGICALLY TREATED WATER
E10: (SECOND) WATER TO BE TREATED (HAVING LOW SALT CONCENTRATION)
E12: CONCENTRATE
F: PERMEATE
U: BACTERICIDE
V: BACTERICIDE
W: BACTERICIDE
X: BACTERICIDE

1. A fresh water generation system comprising:
a first bactericide dosing unit configured to obtain water to be treated A2 by dosing a bactericide into water to be treated A1;
a second bactericide dosing unit configured to obtain dilution water B2 by dosing a bactericide into dilution water B1 having a salt concentration lower than a salt concentration of the water to be treated A1 and having at least one of an organic concentration higher than an organic concentration of the water to be treated A1 and a nutrient salt concentration higher than a nutrient salt concentration of the water to be treated A1;
a mixing unit configured to obtain mixed water by mixing the water to be treated A2 with the dilution water B2;
a third bactericide dosing unit configured to dose a bactericide in an amount represented by the following Expression (1) or (2) into the mixed water:
(XA+XB)≦XM (1)
in which XA, XB and XM each represents an amount of the bactericide as follows:
XA: an amount of the bactericide dosed into the water to be treated A1;
XB: an amount of the bactericide dosed into the dilution water B1; and
XM: an amount of the bactericide dosed into the mixed water,
(CA×FA+CB×FB)/(FA+FB)<CM (2)
in which CA, CB, CM, FA and FB each represents as follows:
CA: a bactericide concentration in the water to be treated A2;
CB: a bactericide concentration in the dilution water B2;
CM: a bactericide concentration in the mixed water after dosing the bactericide into the mixed water;
FA: a flow rate of the water to be treated A1; and
FB: a flow rate of the dilution water B1; and
a first semipermeable membrane treatment unit configured to separate the mixed water into concentrate and permeate.

2. The fresh water generation system according to claim 1, wherein the amount of the bactericide dosed by the third bactericide dosing unit is represented by the following Expression (3) or (4):
(XA+XB)≦XM≦10(XA+XB) (3)
(CA×FA+CB×FB)/(FA+FB)<CM<10(CA×FA+CB×FB)/(FA+FE) (4).

3. The fresh water generation system according to claim 1, wherein the dilution water B1 contains at least one of wastewater, biologically treated water obtained by biologically treating the wastewater, concentrate obtained by subjecting the wastewater to semipermeable membrane treatment, and concentrate obtained by subjecting the biologically treated water to semipermeable membrane treatment.

4. The fresh water generation system according to claim 1, further comprising:
a second semipermeable membrane treatment unit configured to separate second water to be treated E10 which contains wastewater or biologically treated water obtained by biologically treating the wastewater, into concentrate E12 and permeate F, wherein the dilution water B1 contains the concentrate E12.

5. The fresh water generation system according to claim 4, further comprising:
a fourth bactericide dosing unit configured to dose a bactericide U into the second water to be treated E10,
wherein the amount of the bactericide dosed by the third bactericide dosing unit is represented by the following Expression (5) or (6):
(XA+XB+X2)≦XM (5)
in which X2 represents an amount of the bactericide dosed into the second water to be treated E10)
(CA×FA+CB×FB+C2×F2)/(FA+FB+F2)<CM (6)
in which C2 represents a bactericide concentration in the second water to be treated E10 after dosing the bactericide into the second water to be treated E10, and F2 represents a flow rate of the second water to be treated E10).

6. The fresh water generation system according to claim 5, wherein the amount of the bactericide dosed by the third bactericide dosing unit is represented by the following Expression (7) or (8):
(XA+XB+X2)≦XM≦10(XA+XB+X2) (7)
(CA×FA+CB×FB+C2×F2)/(FA+FB+F2)<CM<10(CA×FA+CB×FB+C2×F2)FA+FB+F2) (8).

7. The fresh water generation system according to claim 1, further comprising:
a bactericide amount adjusting unit configured to adjust the amount of the bactericide dosed by the third bactericide dosing unit so as to be proportional to a temperature of the mixed water.

8. The fresh water generation system according to claim 4, further comprising:
a bactericide amount adjusting unit configured to adjust the amount of the bactericide dosed by the third bactericide dosing unit so as to be proportional to at least one of a temperature of the mixed water and a recovery ratio of the second semipermeable membrane treatment unit.

9. The fresh water generation system according to claim 1, wherein the first to third bactericide dosing units dose at least one bactericide selected from the group consisting of an organobromine compound bactericide, chloramines and chloramine derivatives.

10. A fresh water generation method comprising:
a first bactericide dosing step of obtaining water to be treated A2 by dosing a bactericide into water to be treated A1;
a second bactericide dosing step of obtaining dilution water B2 by dosing a bactericide into dilution water B1 having a salt concentration lower than a salt concentration of the water to be treated A1 and having at least one of an organic concentration higher than an organic concentration of the water to be treated A1 and a nutrient salt concentration higher than a nutrient salt concentration of the water to be treated A1;
a mixing step of obtaining mixed water by mixing the water to be treated A2 with the dilution water B2;
a third bactericide dosing step of dosing a bactericide in an amount represented by the following Expression (1) or (2) into the mixed water:
(XA+XB)≦XM (1)
in which XA, XB and XM each represents an amount of the bactericide as follows:
XA: an amount of the bactericide dosed into the water to be treated A1;
XB: an amount of the bactericide dosed into the dilution water B1; and
XM: an amount of the bactericide dosed into the mixed water,
(CA×FA+CB×FB)/(FA+FB)<CM (2)
in which CA, CB, CM, FA and FB each represents as follows:
CA: a bactericide concentration in the water to be treated A2;
CB: a bactericide concentration in the dilution water B2;
CM: a bactericide concentration in the mixed water after dosing the bactericide into the mixed water;
FA: a flow rate of the water to be treated A1; and
FB: a flow rate of the dilution water B1; and
a first semipermeable membrane treating step of separating the mixed water into concentrate and permeate.

11. A fresh water generation system comprising:
a second treatment apparatus comprising a second semipermeable membrane treatment unit configured to generate concentrate E12 and permeate F from water to be treated E10, and a fourth bactericide dosing unit configured to dose a bactericide U into the water to be treated E10; and
a first treatment apparatus comprising a mixing unit configured to mix the concentrate E12 with water to be treated A1 to obtain mixed water A3, and a first semipermeable membrane treatment unit configured to generate concentrate D and permeate C from the mixed water A3 obtained,
wherein the concentrate E12 has a salt concentration lower than a salt concentration of the water to be treated A1, and has at least one of an organic concentration higher than an organic concentration of the water to be treated A1 and a nutrient salt concentration higher than a nutrient salt concentration of the water to be treated A1, and
the bactericides are dosed such that a bactericidal load of the mixed water A3 is higher than a bactericidal load of the water to be treated E10.

12. The fresh water generation system according to claim 11, wherein the bactericidal load has oxidizing power represented by at least one of a total chlorine and a combined chlorine measured by a DPD method.

13. The fresh water generation system according to claim 11, wherein the bactericidal load is represented by a D-value (decimal reduction time).

14. The fresh water generation system according to claim 11, wherein treated water which is treated by each of the first semipermeable membrane treatment unit and the second semipermeable membrane treatment unit has a pH of 4 or less, and the bactericidal load is represented by a hydrogen ion concentration.

15. The fresh water generation system according to claim 11, wherein treated water which is treated by each of the first semipermeable membrane treatment unit and the second semipermeable membrane treatment unit has a pH of 10 or greater, and the bactericidal load is represented by a hydroxide ion concentration.

16. The fresh water generation system according to claim 11, wherein the bactericidal load is represented by reducing power which is confirmed by measuring a consumed amount of sodium hypochlorite.

17. The fresh water generation system according to claim 11, wherein a bactericide is dosed into one or more of the water to be treated E10, the concentrate E12, the water to be treated A1 and the mixed water A3.
